(19) United States
(12) Patent Application Publication
(10) Pub. No.: US 2014/0102754 A1
(43) Pub. Date: Apr. 17, 2014

(54) STRUCTURE OF A NETWORKING CABLE

(71) Applicant: CHING TAI ELECTRIC WIRE & CABLE CO., LTD., New Taipei (TW)

(72) Inventors: Tai-Der Yeh, New Taipei (TW); Wen-Hsiang Han, New Taipei (TW)

(73) Assignee: Ching Tai Electric Wire & Cable Co., Ltd., New Taipei (TW)

(21) Appl. No.: 13/651,693

(22) Filed: Oct. 15, 2012

(51) Int. Cl. H01B 11/02

(52) U.S. Cl. 174/113 R

(57) ABSTRACT

A structure of a networking cable includes a plurality of transmission wires and a plastic outer sheath being a hollow tube for sleeving the transmission wires therein. The plastic outer sheath is formed with at least one hollow compartment extending along a longitudinal length thereof. Capacitance among networking cables can be reduced due to the low dielectric constant of the air inside each hollow compartment, such that the strength of the alien crosstalk can be reduced. The arrangement of shape and symmetry of the hollow compartments with respect to the transmission wires can be used to reduce the alien crosstalk resulted from resonance. Moreover, the usage of raw material is decreased, such that the cost is reduced.

### BACKGROUND OF THE INVENTION

1. Field of the Invention

The present invention relates to a structure of a networking cable, more specifically to a plastic outer sheath having at least one hollow compartment to reduce alien crosstalk.

2. The Prior Arts

Regarding conventional structure of the networking cable, the transmission wires for transferring data are sleeved in an outer sheath made of plastic material. Alien crosstalk is generated when adjacent networking cables of similar characteristics are placed close to each other. This effect becomes greater as the frequency of the transmission is increased. The solution to reduce the alien crosstalk is to increase the distance between the adjacent networking cables or increase the thickness of the outer sheath of the networking cables.

However, increasing the distance between adjacent networking cables decreases the total amount of networking cables in a conduit during installation, so that the solution is not economical. Although increasing the thickness of the outer sheath of the networking cables reduces the alien crosstalk effectively, the cost of raw material also increases. Therefore, a structure of a networking cable which can reduce alien crosstalk and cost of raw material is required.

### SUMMARY OF THE INVENTION

A primary objective of the present invention is to provide a structure of a networking cable, which includes a plurality of transmission wires and a plastic outer sheath being a hollow tube for sleeving the transmission wires therein. The plastic outer sheath is formed with at least one hollow compartment extending along a longitudinal length thereof. Alien crosstalk can be reduced due to the low dielectric constant of the air inside each hollow compartment.

The cross-section of the plastic outer sheath can be a hollow circle or a hollow polygon, and the cross-section of the hollow compartment can be round-shaped, rectangular-shaped, triangular-shaped, etc. Alien crosstalk resulted from resonance can be reduced by the arrangement of the hollow compartment.

The characteristic of the present invention is that the plastic outer sheath having at least one hollow compartment, the capacitance among networking cables can be reduced due to the air with low dielectric constant in the hollow compartment, such that the strength of the alien crosstalk can be reduced. In addition, arrangement of shape and symmetry of the hollow compartments with respect to the transmission wires can be used to reduce the alien crosstalk resulted from resonance. Moreover, the usage of raw material is reduced, such that the cost is also reduced.

### BRIEF DESCRIPTION OF THE DRAWINGS

The present invention will be apparent to those skilled in the art by reading the following detailed description of the preferred embodiments thereof, with reference to the attached drawings, in which:

FIGS. 1A to 1C are the stereogram, the cross stereogram, and the cross-section diagram of the structure of the networking cable of the present invention, respectively.

FIGS. 2A to 2D show the cross-section of several variations of the plastic outer sheath employed in the structure of the networking cable of the present invention.

FIGS. 3A and 3B are the stereogram, and the cross-section diagram of another embodiment of the structure of the networking cable of the present invention, respectively.

FIGS. 4A and 4B are the stereogram, and the cross-section diagram of yet another embodiment of the structure of the networking cable of the present invention, respectively.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

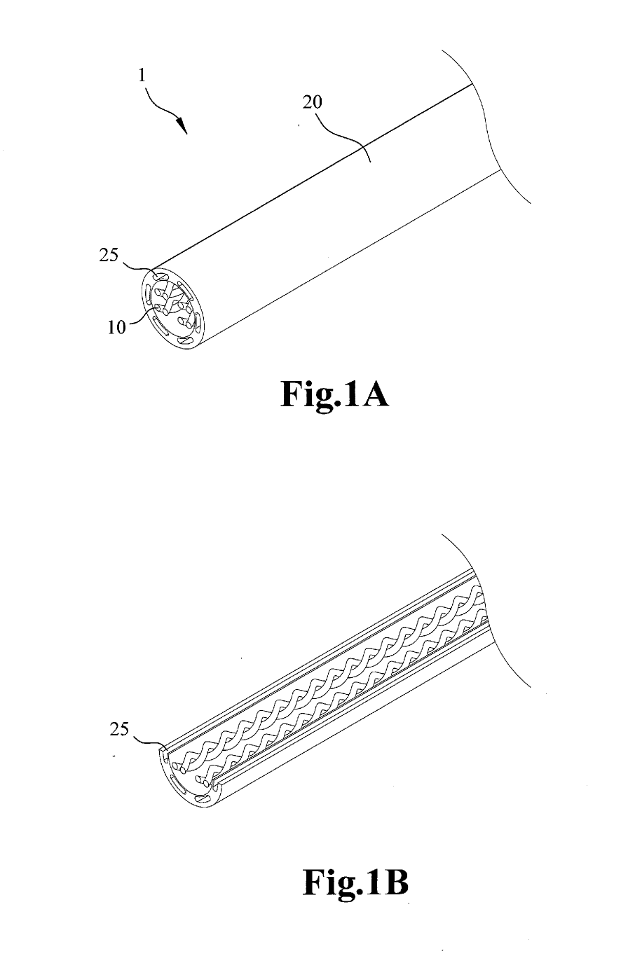

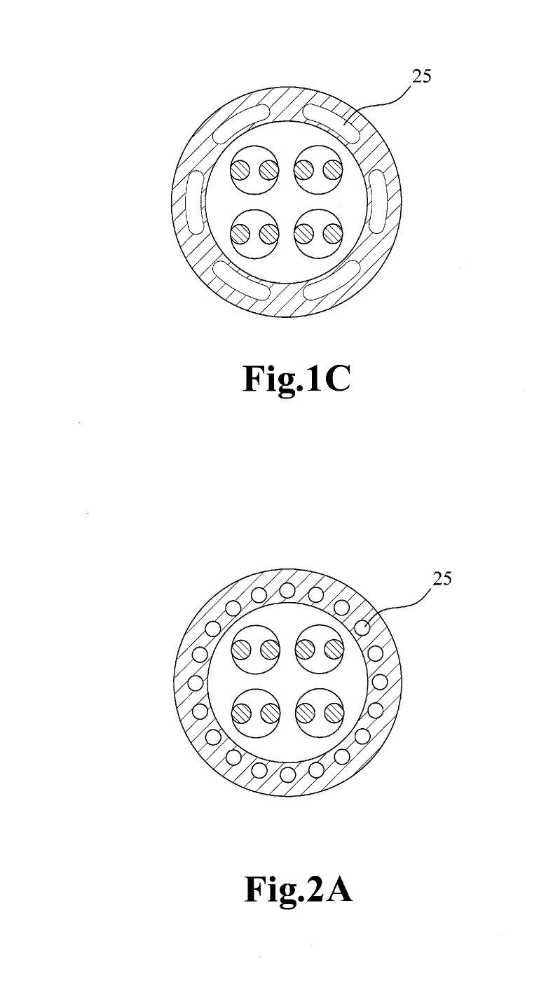

FIGS. 1A to 1C respectively shows the stereogram, the cross stereogram, and the cross-section diagram of the structure of the networking cable of the present invention. As shown in FIGS. 1A to 1C, the structure of the networking cable 1 of the present invention includes a plurality of transmission wires 10 and a plastic outer sheath 20. The plastic outer sheath 20 is a hollow tube for sleeving the transmission wires 10 therein. The plastic outer sheath 20 is formed with at least one hollow compartment 25. Each of the transmission wires 10 is made of insulated twisted wires. As shown in FIGS. 1B and 1C, the cross-section of the plastic outer sheath 20 is a hollow circle, the hollow compartments 25 extend along the longitudinal length of the plastic outer sheath 20, and the cross-sections of the hollow compartments 25 are arc-shaped. Further, hollow compartments 25 can be arranged symmetrically with respect to the transmission wires 10.

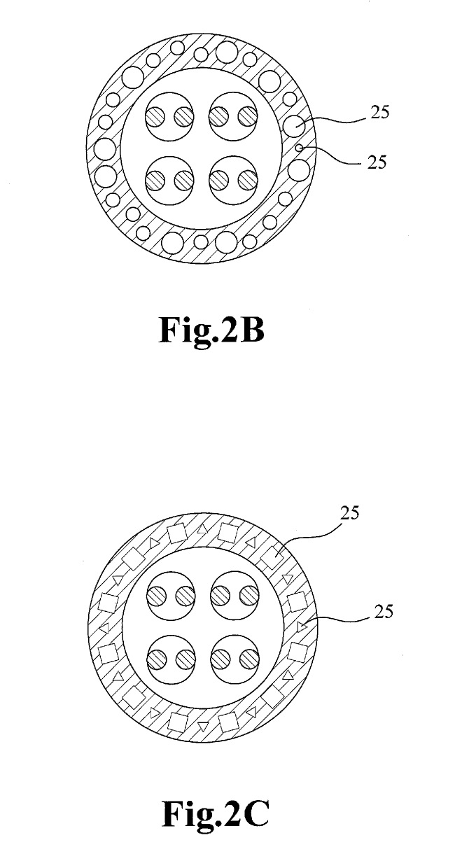

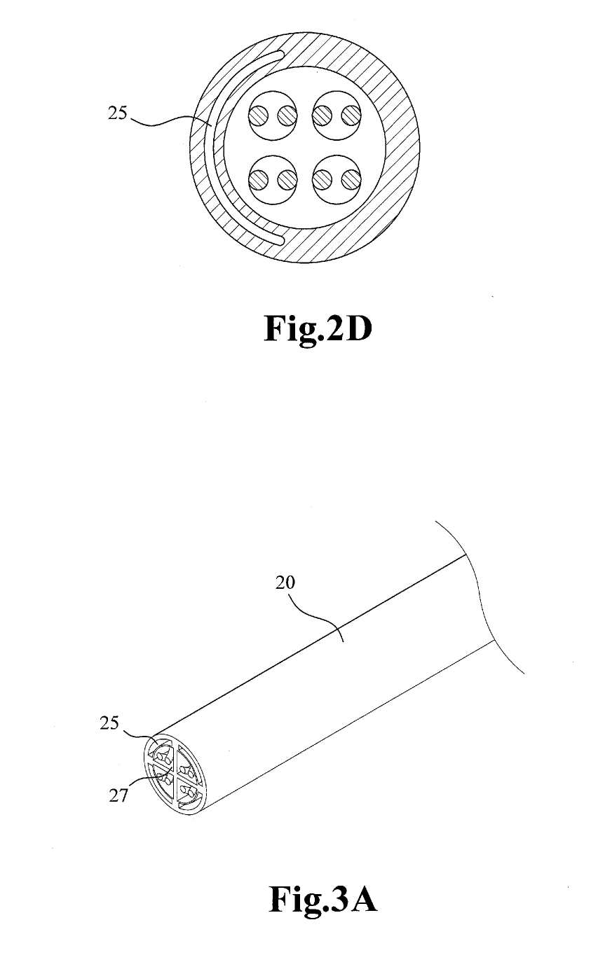

FIGS. 2A to 2D show the cross-section of several variations of the plastic outer sheath 20 employed in the structure of the networking cable of the present invention. As shown in FIGS. 2A to 2D, the shape and symmetry of the hollow compartments 25 with respect to the transmission wires 10 in the plastic outer sheath 20 can be varied appropriately. As shown in FIG. 2A, the plastic outer sheath 20 is formed with a plurality of hollow compartments 25 having round-shaped cross-section. The hollow compartments 25 are same size and are arranged symmetrically with respect to the transmission wires 10. As shown in FIG. 2B, the plastic outer sheath 20 is formed with a plurality of hollow compartments 25 having round-shaped cross-section. The hollow compartments 25 have different sizes and are arranged asymmetrically with respect to the transmission wires 10. As shown in FIG. 2C, the plastic outer sheath 20 is formed with a plurality of hollow compartments 25 having rectangular-shaped and triangular-shaped cross-sections, and the hollow compartments 25 are arranged symmetrically with respect to the transmission wires 10. As shown in FIG. 2D, the plastic outer sheath 20 is formed with a hollow compartment 25 having arc-shaped in cross-section. These figures are examples to explain the variations, and other modification in shapes and symmetry of the hollow compartments 25 sharing the same spirit are in the range of the present invention.

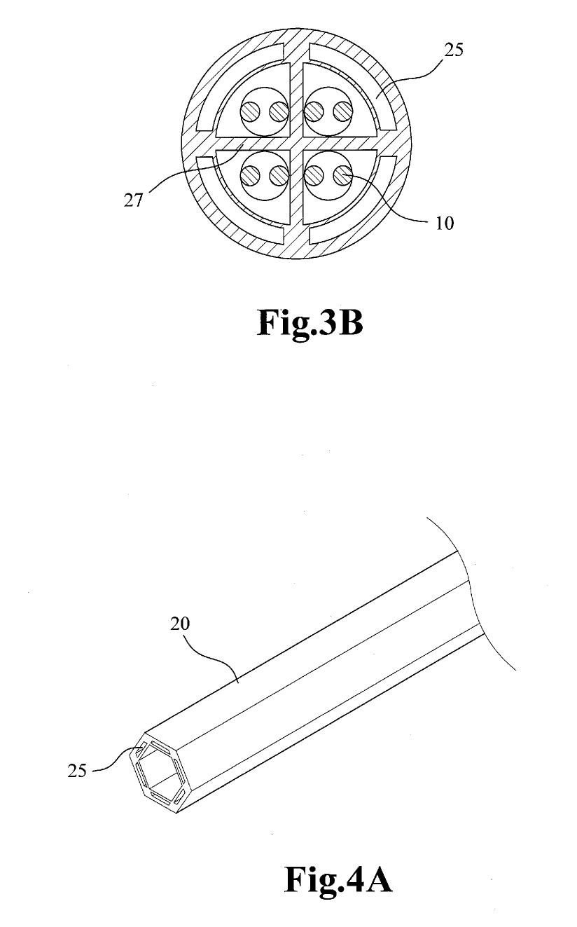

FIGS. 3A and 3B respectively shows the stereogram and the cross-section diagram of another embodiment of the structure of the networking cable of the present invention. As shown in FIGS. 3A and 3B, a support structure 27 in the form of an interconnected vertical and horizontal plate extends along the longitudinal direction of the cable. Support structure 27 is sleeved by the outer sheath 20 in such a manner to separate the plurality of transmission wires 10 into four groups.

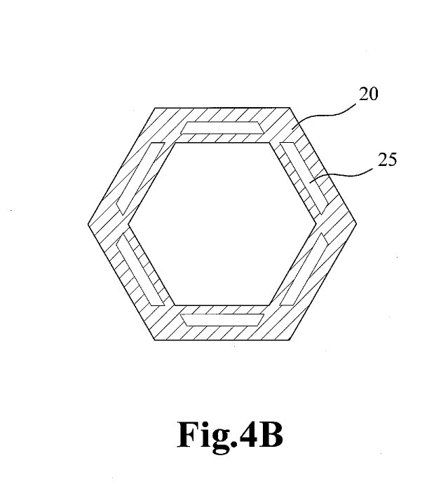

FIGS. 4A and 4B respectively shows the stereogram and the cross-section diagram of yet another embodiment of the structure of the networking cable of the present invention. As shown in FIGS. 4A and 4B, the cross-section of the plastic outer sheath 20 is a hollow hexagon, the plastic outer sheath 20 is formed with a plurality of the hollow compartments 25 having rectangular-shaped. The hollow hexagonal is only an example to explain the cross-section of the plastic outer sheath 20 can be a hollow polygon

The characteristic of the present invention is that the plastic outer sheath 20 is formed with at least one hollow compartment 25, the capacitance among networking cables can be reduced due to the air with low dielectric constant in the hollow compartment 25, such that the strength of the alien crosstalk can be reduced. In addition, the arrangement of shape and symmetry of the hollow compartments 25 with respect to the transmission wires 10 can be used to reduce the alien crosstalk resulted from resonance. Moreover, the usage of raw material is decreased, such that the cost is reduced.

Although the present invention has been described with reference to the preferred embodiments thereof, it is apparent to those skilled in the art that a variety of modifications and changes may be made without departing from the range of the present invention which is intended to be defined by the appended claims.

What is claimed is:

1. A structure of a networking cable, comprising:
a plurality of transmission wires; and
a plastic outer sheath being a hollow tube for sleeving the transmission wires therein, and formed with at least one hollow compartment extending in a longitudinal length thereof for reducing alien crosstalk.

2. The structure of the networking cable according to claim 1, wherein a cross-section of the plastic outer sheath is a hollow circle.

3. The structure of the networking cable according to claim 2, wherein a cross-section of the at least one hollow compartment is arc-shaped.

4. The structure of the networking cable according to claim 2, wherein the plastic outer sheath is formed with more than two of the hollow compartments, cross-sections of the hollow compartments being round-shaped and being arranged symmetrically with respect to the plurality of transmission wires.

5. The structure of the networking cable according to claim 2, wherein the plastic outer sheath is formed with more than two of the hollow compartments, cross-sections of the hollow compartments are round-shaped and the hollow compartments are arranged asymmetrically with respect to the plurality of transmission wires.

6. The structure of the networking cable according to claim 2, wherein the plastic outer sheath is formed with more than two of the hollow compartments, cross-sections of the hollow compartments being rectangular-shaped and triangular-shaped and being arranged symmetrically with respect to the plurality of transmission wires.

7. The structure of the networking cable according to claim 1, wherein a cross-section of the plastic outer sheath is a hollow polygon.

8. The structure of the networking cable according to claim 7, wherein the plastic outer sheath is formed with more than two of the hollow compartments, cross-sections of the hollow compartments being rectangular-shaped and being arranged symmetrically with respect to the plurality of transmission wires.

9. The structure of the networking cable according to claim 1, wherein the plastic outer sheath further includes a support structure formed therein, and the support structure is cross-shaped and sleeved in the plastic outer sheath and extends along an axial length thereof in such a manner to separate the transmission wires into groups.

10. The structure of the networking cable according to claim 1, wherein the plastic outer sheath is formed with more than two of the hollow compartments, cross-sections of the hollow compartments being arc-shaped and being arranged symmetrically with respect to the plurality of transmission wires.

11. The structure of the networking cable according to claim 1, wherein each of the transmission wires is made of insulated twisted wires.
